(19) United States
(12) Patent Application Publication
(10) Pub. No.: US 2018/0141258 A1
(43) Pub. Date: May 24, 2018

(54) PIN EXTRUDER

(71) Applicant: TROESTER GmbH & Co. KG, Hanover (DE)

(72) Inventors: Mathias Zabel, Wieckenberg (DE); Michael Zelleroehr, Hannover (DE)

(21) Appl. No.: 15/811,709

(22) Filed: Nov. 14, 2017

(30) Foreign Application Priority Data
Nov. 18, 2016 (DE) 10 2016 122 277.1

(51) Int. Cl. B29C 47/66; B29C 47/60; B29C 47/38; B30B 11/24

(52) U.S. Cl. CPC B29C 47/667; B29C 47/605; B29C 47/0009; B30B 11/248; B29C 47/38

(57) ABSTRACT

In an embodiment, the present invention provides a pin extruder, including a screw conveyor for conveying plastics, the screw conveyor having a plurality of pins each arranged in a respective pin row, the pin rows being arranged in a plurality of consecutive planes in a conveying direction of the screw conveyor. A distance between the planes of at least individual pin rows varies in the conveying direction.

### CROSS-REFERENCE TO PRIOR APPLICATION

Priority is claimed to German Patent Application No. DE 10 2016 122 277.1, filed on Nov. 18, 2016, the entire disclosure of which is hereby incorporated by reference herein.

### FIELD

The invention relates to a pin extruder with a screw conveyor for conveying plastics, particularly elastomers or rubber, with a plurality of pins each arranged in a respective pin row, the pin rows being arranged in a plurality of consecutive planes in the conveying direction of the screw conveyor.

### BACKGROUND

Pin extruders and their advantages over other cold-feed machines in terms of their throughput capacity and energy consumption have been known for some time. Pin extruders are used in the rubber-processing industry, especially for screw conveyors with external diameters in excess of 120 mm. Extruders of this design are described in DE 22 35 784 C3 and DE 30 03 615 C2 for example.

The pins extend up to the screw conveyor and are fixed to the housing, the screw conveyor flights comprising gaps which allow the relevant pin to pass through at this axial height.

Higher outputs or mass throughputs respectively and good homogeneity of the extruded product are possible with this type of extruder in comparison with conventional cold-feed rubber extruders without pins.

Even though it is frequently assumed that the higher throughput achieved by a pin extruder of this type compared with an extruder without pins is due to the fact that rotational flow in the screw conveyor channel is obstructed, closer investigations indicate that the throughput gains are due to the increase in the relative speed between the fixed pins on the one hand and the rotating screw conveyor flanks on the other hand. In practice, the extrudate is constantly pushed in front of the pins and pressed partially and effectively towards the extrusion nozzle through the gaps in the screw flights, and specifically in the downstream portion of the conveyed extrudate.

In addition to the usual embodiments, pin extruders with improved characteristics and functions are known in the art. In an extruder according to DE 8 79 913 the pins are used to create retention surfaces, which can be used to help regulate the resistance for the conveyed material.

The object of the pins in an extruder according to DE 35 34 097 A1 is also to prevent the screw conveyor flights coming into contact with the walls of the extruder housing.

Arranging the pins such that they are fixed to the screw conveyor, thus creating a kinematic reversal process, is also known in the art. See DE 71 03 071 for an example of this. In this solution, two pin configurations with different arrangements and designs are meshed together. The disadvantage of this arrangement is that there is no conveying action in this case, although the mixing action of these screw conveyors is good. On the other hand, this solution is only suitable for use with twin screw extruders.

A similar solution, which is also suitable for single extruders in principle, is disclosed in DE 26 50 248. In this solution, rows of pins run in a form of annular grooves, although these are not penetrating, but are formed by a large number of protrusions extending inwards. In practical terms, there is once again no conveying action in this case, although there is considerable mixing action, as required for plastification and homogenization of the extrudate.

One disadvantage of the pin extruders of the prior art is that a large number of pins are required, which means that the flow channel is severely restricted by the pin cross-sections. This leads to a considerable loss in pressure, with the result that the advantage of the pin extruder in terms of throughput gains is offset by the large reduction in pressure in the pin area and the resulting loss in throughput in this case.

### SUMMARY

In an embodiment, the present invention provides a pin extruder, comprising: a screw conveyor configured to convey plastics, the screw conveyor having a plurality of pins each arranged in a respective pin row, the pin rows being arranged in a plurality of consecutive planes in a conveying direction of the screw conveyor, wherein a distance between the planes of at least individual pin rows varies in the conveying direction.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a side view of a screw conveyor of a pin extruder with a plurality of pins arranged in pin rows; and

FIG. 2 is a phase diagram showing the pins passing through a respective gap in the flights in the screw conveyor.

### DETAILED DESCRIPTION

A pin extruder is thus provided according to the invention in which the distance between the planes of at least individual pin rows in the conveying direction varies between an inlet and an outlet of the screw conveyor, at least one pin in a first pin row in a first plane having a small cross-sectional surface area, and in particular a smaller diameter than at least one pin in a second pin row a shorter distance from an outlet in a second plane located behind the first plane in the conveying direction, and/or the pins being arranged and distributed over the circumference of the screw conveyor at different angular positions such that at least individual pins pass through an associated gap in the flights of the screw conveyor one after the other, or in other words not at the same time when the screw conveyor rotates.

In comparison with pin extruders of the prior art, the distance between pin planes in the conveying direction increases at least between some of the pin planes, wherein at least two concordant pin plane distances or even one reduced distance between two consecutive pin planes are of course covered by the object of the invention.

In this case, the number of pin planes between the inlet and the outlet of the extruder may also be lower than in the prior art or may remain unchanged, resulting in a smaller pin plane distance adjacent to the inlet and a larger pin plane distance adjacent to the outlet compared with the prior art.

In addition or alternatively, the cross-sectional shape of the pins also varies between different pin rows. It has thus been shown that, compared with the pins in subsequent pin rows in the conveying direction, a pin with a larger cross-sectional surface area in the intake region of the screw conveyor leads to a significantly improved plastification performance whether the radial length of the pins is the same or different.

Furthermore, the pins in the different pin planes are arranged with an angular offset in relation to the axis of the screw conveyor, with the result that said pins do not reach or pass through the respective gap in the flights simultaneously, but at staggered intervals, when the extruder is operating with the screw conveyor rotating. This results in optimum smooth running of the extruder, especially as it prevents pressure surges and the resulting wear on the screw conveyor.

Although each of the above-mentioned embodiments of the extruder already offers considerable advantages in its own right, combining the various measures in particular leads to a surprisingly advantageous outcome.

More efficient plastification of the conveyed mixture is achieved by the plurality of pins in the intake area or adjacent to the intake area of the screw conveyor respectively. Plastification performance can be improved still further due to the increased maximum cross-sectional surface area or volume of the pins, pin rows adjacent to the inlet respectively, with the result that there is no likelihood of an adverse effect on homogenization even if the number of pin rows is reduced.

The invention is based on the discovery that plastification performance is a function of the cross-sectional surface area, and in particular the diameter, especially in the case of cylindrical pins, and increases in proportion with said diameter.

The resulting loss in throughput caused by the larger gap in the flights is negligible because this region is close to the inlet and a considerable distance from the outlet end of the screw conveyor, and as such is only affected to a relatively small extent by the flow. The screw conveyor is also not yet 100% full in this region.

At present it is even assumed that the correspondingly larger gaps in the flights have a positive effect on intake behavior as they allow more space for the conveyed mixture.

At the same time, a reduced number of pin rows and decreasing sizes of the gaps in the flights lead to a reduction in flow, especially in the region of the top of a screw conveyor, causing the drag flow element, and thus throughput, to increase. Plastification still only plays a minor role towards the top of the screw conveyor and has preferably already been completed in the vicinity of the last pin row.

There are many possible embodiments of the invention. To further clarify the fundamental principle, the drawing shows an example of one of these embodiments, which is then described below.

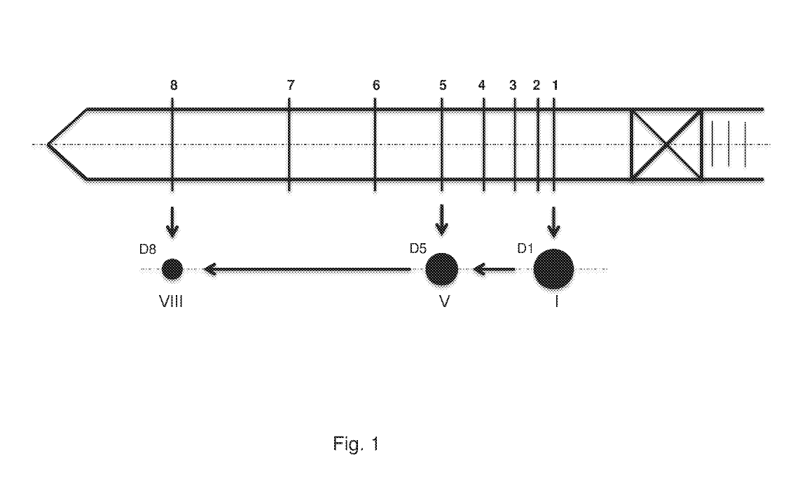

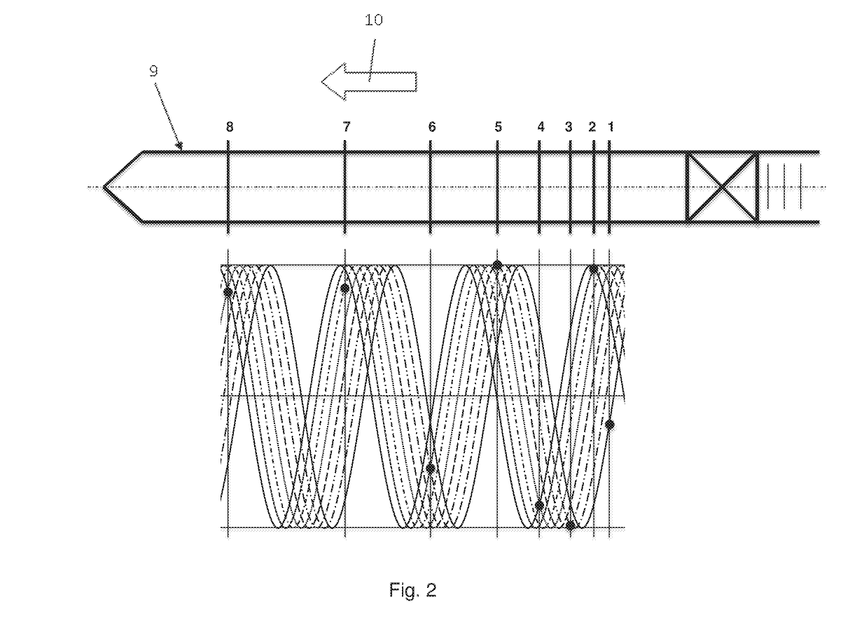

The pin extruder according to the invention is explained below with the aid of FIGS. 1 and 2. The pin extruder has a screw conveyor 9 for conveying plastics, particularly elastomers, rubber or similar. The pin extruder is equipped with a plurality of pins I to VIII each arranged in a respective pin row 1 to 8 to ensure improved mixing. The pin rows 1 to 8 are arranged in the conveying direction 10 of the screw conveyor 9 such that the distance A1 to A7 between the planes increases from plane to plane in the conveying direction 10.

As shown in FIG. 1, the diameter D1 to D8 of the pins, which are cylindrical in this case, also decreases accordingly from plane to plane in the conveying direction 10, thus ensuring more efficient plastification of the conveyed mixture.

Pins I to VIII are also arranged over the circumference of the screw conveyor 9 such that they are offset at different angular positions so that at least individual pins I to VIII pass through a respective associated, but not illustrated gap in the flights of the screw conveyor 9 one after the other when the screw conveyor 9 rotates, as shown in the phase diagram illustrated in FIG. 2 showing pins I to VIII passing through a respective gap in the flights of the screw conveyor 9. In the example shown, the pins I to VIII of the various pin rows 1 to 8 pass through the associated gap in the flights in the sequence 1-6-3-5-4-7-2-8.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 pin row

2 pin row

3 pin row

4 pin row

5 pin row

6 pin row

7 pin row

8 pin row

9 screw conveyor

10 conveying direction

I to VIII pin

A1 to A7 distance

D1 to D8 diameter

1. A pin extruder, comprising:
a screw conveyor configured to convey plastics, the screw conveyor having a plurality of pins each arranged in a respective pin row, the pin rows being arranged in a plurality of consecutive planes in a conveying direction of the screw conveyor,
wherein a distance between the planes of at least individual pin rows varies in the conveying direction.

2. The pin extruder according to claim 1, wherein the distance between the planes of at least individual pin rows increases in the conveying direction.

3. A pin extruder, comprising:
a screw conveyor configured to convey plastics, the screw conveyor having a plurality of pins each arranged in a respective pin row, the pin rows being arranged in a plurality of consecutive planes in a conveying direction of the screw conveyor,
wherein at least one pin in a first pin row in a first plane has a smaller cross-sectional surface area than at least one pin in a second pin row a shorter distance from an outlet in a second plane located behind the first plane in the conveying direction.

4. A pin extruder, comprising:
a screw conveyor configured to convey plastics, the screw conveyor having a plurality of pins each arranged in a respective pin row, the pin rows being arranged in a plurality of consecutive planes in a conveying direction of the screw conveyor,
wherein at least individual pins pass through a respective associated gap in flights of the screw conveyor one after the other when the screw conveyor rotates.

5. The pin extruder according to claim 4, wherein the pins are arranged and distributed such that the time taken to pass through the gap in the flights follows a fixed sequence.

6. The pin extruder according to claim 4, wherein the pin rows are arranged in a cross-sectional plane with respect to the screw conveyor.

7. The pin extruder according to claim 4, wherein the pins are arranged such that they are evenly distributed over a circumference of the screw conveyor in relation to angular positions of the gaps in the flights.

8. The pin extruder according to claim 3, wherein the cross-sectional surface area comprises a diameter of the at least one pin in the first pin row in the first plane.

9. The pin extruder according to claim 5, wherein the fixed sequence comprises a constant sequence.

10. The pin extruder according to claim 1, wherein the plastics comprise elastomers or rubber.

11. The pin extruder according to claim 3, wherein the plastics comprise elastomers or rubber.

12. The pin extruder according to claim 4, wherein the plastics comprise elastomers or rubber.
